(19) United States
(12) Patent Application Publication
(10) Pub. No.: US 2024/0070545 A1
(43) Pub. Date: Feb. 29, 2024

(54) INFORMATION PROCESSING APPARATUS, LEARNING APPARATUS, INFORMATION PROCESSING SYSTEM, INFORMATION PROCESSING METHOD, LEARNING METHOD, INFORMATION PROCESSING PROGRAM, AND LEARNING PROGRAM

(71) Applicant: FUJIFILM Corporation, Tokyo (JP)

(72) Inventors: Taiki FURUKAWA, Nagoya (JP); Shotaro MISAWA, Tokyo (JP); Hirokazu YARIMIZU, Tokyo (JP); Ryuji KANO, Tokyo (JP); Tomoki TANIGUCHI, Tokyo (JP); Tomoko OHKUMA, Tokyo (JP); Kohei ONODA, Tokyo (JP)

(73) Assignee: FUJIFILM Corporation, Tokyo (JP)

(21) Appl. No.: 18/458,135

(22) Filed: Aug. 29, 2023

(30) Foreign Application Priority Data
Aug. 31, 2022 (JP) 2022-138807
Feb. 28, 2023 (JP) 2023-030561

(51) Int. Cl. G06N 20/00

(52) U.S. Cl. CPC G06N 20/00

(57) ABSTRACT

An information processing apparatus includes at least one processor, in which the processor is configured to: for a machine learning model that uses a document data group including a plurality of document data as input and outputs output data, derive an evaluation value in the machine learning model for each document data included in the document data group.

### CROSS-REFERENCE TO RELATED APPLICATIONS

This application claims priority from Japanese Patent Application No. 2022-138807, filed on Aug. 31, 2022, and Japanese Patent Application No. 2023-030561, filed on Feb. 28, 2023, the entire disclosures of which are incorporated by reference herein.

### BACKGROUND

### Technical Field

The present disclosure relates to an information processing apparatus, a learning apparatus, an information processing system, an information processing method, a learning method, an information processing program, and a learning program.

### Related Art

There is known a technique of deriving an evaluation value of input data in a machine learning model in order to interpret the machine learning model. There is known a technique of deriving a degree of contribution of the input data to the derivation of output data in the machine learning model as such an evaluation value, for example, in order to interpret the machine learning model. Examples of the technique of deriving the degree of contribution include a method, such as local interpretable model-agnostic explanations (LIME). In addition, a data group in which a plurality of data are grouped is used as the input data to output the output data from the machine learning model. For example, JP 2020-113218 A discloses a machine learning model in which a text including a plurality of word data is used as the input data. JP 2020-113218 A describes a technique of assigning a degree of contribution to a classification result for each word obtained by dividing the text in the machine learning model that uses the text as the input data and outputs the classification result.

However, it cannot be said that in the related art is sufficient to obtain the evaluation value in the machine learning model that uses a document data group including a plurality of document data as input. For example, in the technique described in JP 2020-113218 A, in a case in which the text is the document data group including the plurality of document data, the degree of contribution for each word can be derived, whereas it is insufficient to derive the degree of contribution for each document data.

### SUMMARY

The present disclosure has been made in view of the above circumstances, and is to provide an information processing apparatus, a learning apparatus, an information processing method, an information processing system, a learning method, an information processing program, and a learning program which can obtain, for each document data, an evaluation value in a machine learning model that uses a document data group including a plurality of document data as input.

In order to achieve the above object, a first aspect of the present disclosure relates to an information processing apparatus comprising: at least one processor, in which the processor is configured to: for a machine learning model that uses a document data group including a plurality of document data as input and outputs output data, derive an evaluation value in the machine learning model for each document data included in the document data group.

A second aspect relates to the information processing apparatus according to the first aspect, in which the processor is configured to: perform at least one of specification of the document data, which is a display target, from the document data group or specification of a display order of a document according to the document data based on the derived evaluation value.

A third aspect relates to the information processing apparatus according to the first aspect, in which the processor is configured to: use each document data as input of the machine learning model to acquire document unit output data which is output for each document data; and derive the evaluation value for each document data based on the document unit output data.

A fourth aspect relates to the information processing apparatus according to the third aspect, in which the evaluation value has a correlation with the document unit output data.

A fifth aspect relates to the information processing apparatus according to the first aspect, in which the processor is configured to: normalize each document data included in the document data group; and derive the evaluation value for each normalized document data.

A sixth aspect relates to the information processing apparatus according to the first aspect, in which the processor is configured to: extract a plurality of word data from each document data included in the document data group; derive the evaluation value in the machine learning model as a word unit evaluation value for each word data; and derive the evaluation value according to a statistical value of the word unit evaluation value of the word data included in the document data for each document data.

A seventh aspect relates to the information processing apparatus according to the first aspect, in which the document data having a greatest first evaluation value, which is derived for each document data, is used as first document data, and each of the plurality of document data other than the first document data included in the document data group is used as second document data, and the processor is configured to: use each combination data in which the first document data and the second document data are combined as input of the machine learning model to derive a second evaluation value from output data which is output for each combination data.

An eighth aspect relates to the information processing apparatus according to the seventh aspect, in which the processor is configured to: give a first display priority to the first document data; and give a second display priority, which is lower than the first display priority, to the second document data based on the second evaluation value.

A ninth aspect relates to the information processing apparatus according to the first aspect, in which the processor is configured to: extract a plurality of word data from each document data included in the document data group; derive the evaluation value in the machine learning model as a word unit evaluation value for each word data; derive a first statistical value of the word unit evaluation value of the word data included in the document data for each document data to give a first evaluation value to first evaluation value document data which is the document data having a greatest first statistical value; derive, for a plurality of combination data in which the first evaluation value document data, and each of the plurality of document data other than the first evaluation value document data included in the document data group are combined, a second statistical value of the word unit evaluation value of the word data included in the combination data for each combination data to give a second evaluation value, which is lower than the first evaluation value, to second evaluation value document data which is the document data having a greatest second statistical value; and set, in derivation of the second statistical value, the word unit evaluation value of the word data included in the first evaluation value document data among the word data included in the document data combined with the first evaluation value document data to be relatively lower than the word unit evaluation value of the word data which is not included in the first evaluation value document data.

A tenth aspect relates to a learning apparatus of a machine learning model that uses a plurality of document data as input and outputs output data, the learning apparatus comprising: at least one processor, in which the processor is configured to: use, for a plurality of document data for training, each document data for training as input of the machine learning model to acquire output data which is output for each document data for training; calculate, for a part of the document data for training from the plurality of document data for training, a loss function representing a degree of difference between correct answer data and the output data for each document data for training based on the output data obtained for each document data for training and the correct answer data; and update the machine learning model based on the loss function.

An eleventh aspect relates to the learning apparatus according to the tenth aspect, in which the processor is configured to: extract the part of document data for training based on a degree of similarity between the output data and the correct answer data.

A twelfth aspect relates to the learning apparatus according to the tenth aspect, in which the processor is configured to: calculate, also for another document data for training other than the part of document data for training, the loss function with a weight smaller than a weight of the part of document data for training for each data for training; and update the machine learning model based also on the loss function of the other document data for training.

A thirteenth aspect relates to the learning apparatus according to the tenth aspect, in which the processor is configured to: calculate, for the part of document data for training, the loss function by performing weighting based on the output data obtained for each document data for training and the correct answer data.

A fourteenth aspect relates to the learning apparatus according to the thirteenth aspect, in which the processor is configured to: set weighting to be larger as a degree of similarity between the output data and the correct answer data is higher.

A fifteenth aspect relates to the learning apparatus according to the tenth aspect, in which the processor is configured to: repeatedly update the machine learning model based on the loss function obtained from the part of document data for training; and change the number of the part of document data for training to be extracted, according to the number of updates of the machine learning model.

A sixteenth aspect relates to the learning apparatus according to the tenth aspect, in which each document data for training is given with a label representing a type of an associated prediction result of the machine learning model, and the processor is configured to: extract the document data for training for each type of the label.

A seventeenth aspect relates to an information processing apparatus comprising: at least one processor, in which the processor is configured to: for a machine learning model that uses a document data group including a plurality of document data as input and outputs output data, derive an evaluation value in the machine learning model for each document data included in the document data group, and the machine learning model is a machine learning model trained by a learning apparatus of the machine learning model that uses the document data group including the plurality of document data as input and outputs the output data, the learning apparatus including: at least one processor for training, in which the processor for training is configured to: use each document data for training included in a document data group for training as input of the machine learning model to acquire output data which is output for each document data for training; calculate, for a part of the document data for training from the document data group for training, a loss function representing a degree of difference between correct answer data and the output data for each document data for training based on the output data obtained for each document data for training and the correct answer data; and update the machine learning model based on the loss function.

An eighteenth aspect relates to an information processing system comprising: the information processing apparatus according to the present disclosure; and the learning apparatus according to the present disclosure.

In addition, in order to achieve the above object, a nineteenth aspect of the present disclosure relates to an information processing method executed by a processor of an information processing apparatus including at least one processor, the information processing method comprising: for a machine learning model that uses a document data group including a plurality of document data as input and outputs output data, deriving an evaluation value in the machine learning model for each document data included in the document data group.

In addition, in order to achieve the above object, a twentieth aspect of the present disclosure relates to an information processing program causing a processor of an information processing apparatus including at least one processor, to execute a process comprising: for a machine learning model that uses a document data group including a plurality of document data as input and outputs output data, deriving an evaluation value in the machine learning model for each document data included in the document data group.

In addition, a twenty-first aspect of the present disclosure relates to a learning method comprising: via a processor, using, for a plurality of document data for training, each document data for training as input of a machine learning model to acquire output data which is output for each document data for training; calculating, for a part of the document data for training from the plurality of document data for training, a loss function representing a degree of difference between correct answer data and the output data for each document data for training based on the output data obtained for each document data for training and the correct answer data; and updating the machine learning model based on the loss function.

In addition, a twenty-second aspect of the present disclosure relates to a learning program causing a processor to execute a process comprising: using, for a plurality of document data for training, each document data for training as input of a machine learning model to acquire output data which is output for each document data for training; calculating, for a part of the document data for training from the plurality of document data for training, a loss function representing a degree of difference between correct answer data and the output data for each document data for training based on the output data obtained for each document data for training and the correct answer data; and updating the machine learning model based on the loss function.

According to the present disclosure, it is possible to obtain the evaluation value for each document data in the machine learning model that uses the document data group including the plurality of document data as input.

### BRIEF DESCRIPTION OF THE DRAWINGS

FIG. 1 is a configuration diagram schematically showing one example of an overall configuration of an information processing system according to an embodiment.

FIG. 2 is a diagram for describing input and output of a prognosis prediction model.

FIG. 3 is a diagram showing an outline of processing in a training phase of the prognosis prediction model.

FIG. 4 is a block diagram showing one example of a configuration of an information processing apparatus according to a first embodiment.

FIG. 5 is a functional block diagram showing one example of a configuration of the information processing apparatus according to the first embodiment.

FIG. 6 is a diagram for describing an action of the information processing apparatus according to the first embodiment.

FIG. 7 is a flowchart showing one example of a flow of information processing by the information processing apparatus according to the first embodiment.

FIG. 8 is a diagram showing one example of a state in which document data, which is a display target, is displayed on a display unit in a specified display order.

FIG. 9 is a flowchart showing one example of a flow of information processing according to a modification example 1.

FIG. 10 is a diagram for describing an action of an information processing apparatus according to the modification example 1.

FIG. 11 is a functional block diagram showing one example of a configuration of an information processing apparatus according to a second embodiment.

FIG. 12 is a diagram for describing an action of the information processing apparatus according to the second embodiment.

FIG. 13 is a flowchart showing one example of a flow of information processing by the information processing apparatus according to the second embodiment.

FIG. 14 is a flowchart showing a modification example of the flow of the information processing by the information processing apparatus according to the second embodiment.

FIG. 15 is a configuration diagram schematically showing one example of an overall configuration of an information processing system according to a third embodiment.

FIG. 16 is a diagram showing one example of training data according to the third embodiment.

FIG. 17 is a block diagram showing one example of a configuration of an information processing apparatus according to the third embodiment.

FIG. 18 is a functional block diagram showing one example of a configuration of the information processing apparatus according to the third embodiment.

FIG. 19 is a diagram for describing learning processing according to the third embodiment.

FIG. 20 is a flowchart showing one example of a flow of the learning processing by a learning apparatus according to the third embodiment.

### DETAILED DESCRIPTION

Hereinafter, the description of embodiments of the present disclosure will be made in detail with reference to the drawings. It should be noted that the present embodiment does not limit the technique of the present disclosure.

### First Embodiment

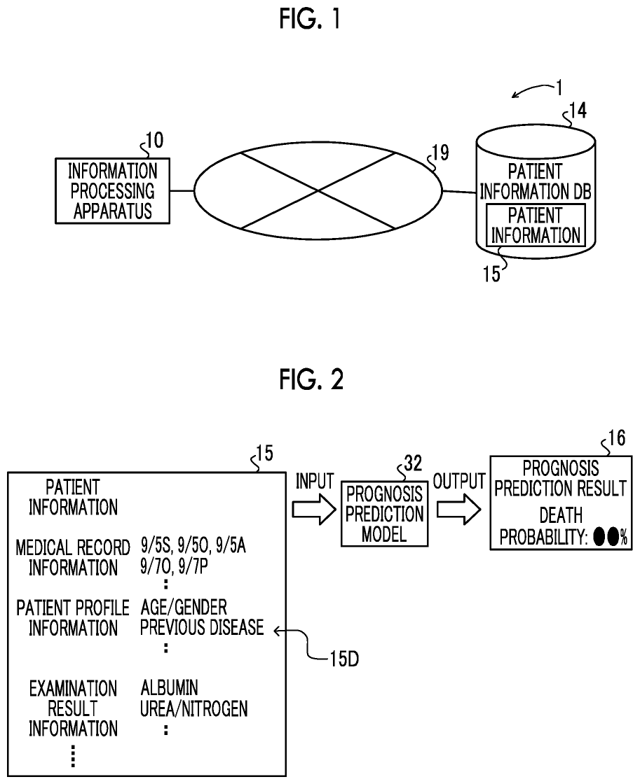

First, one example of an overall configuration of an information processing system according to the present embodiment will be described. FIG. 1 shows a configuration diagram showing one example of an overall configuration of an information processing system 1 according to the present embodiment. As shown in FIG. 1, the information processing system 1 according to the present embodiment comprises an information processing apparatus 10 and a patient information database (DB) 14. The information processing apparatus 10 and the patient information DB 14 are connected to each other via a network 19 by the wired communication or the wireless communication.

Patient information 15 related to a plurality of patients is stored in the patient information DB 14. The patient information DB 14 is realized by a storage medium, such as a hard disk drive (HDD), a solid state drive (SSD), and a flash memory, provided in a server apparatus in which a software program for providing functions of a database management system (DBMS) to a general-purpose computer is installed.

As one example, the patient information 15 according to the present embodiment is document data 15D representing a document related to medical care of a specific patient. As shown in FIG. 2, the document data 15D includes, for example, medical record information, patient profile information, and examination result information. It should be noted that, in the present embodiment, the “document” is information in which at least one of a word or a sentence is a constituent element. For example, the document may include only one word, or may include a plurality of sentences. In the example shown in FIG. 2, as the document data 15D which is the medical record information, five of “9/5S”, “9/50”, “9/5A”, “9/7O”, and “9/7P” are shown. In addition, as the document data 15D which is the patient profile information, two of “age/gender” and “previous disease” are shown. In addition, as the document data 15D which is the examination result information, two of “albumin” (examination value of albumin) and “urea/nitrogen” (examination value of urea and examination value of nitrogen) are shown.

The patient information 15 is stored in the patient information DB 14 in association with identification information for identifying the patient for each specific patient. The patient information 15 according to the present embodiment is one example of a document data group according to the present disclosure, and the document data 15D according to the present embodiment is one example of document data according to the present disclosure.

The information processing apparatus 10 is an apparatus having a function of providing a user with a prognosis prediction result using a prognosis prediction model 32, and the patient information 15 according to a degree of influence on the prognosis prediction result, regarding any patient. The prognosis prediction model 32 according to the present embodiment is one example of a machine learning model according to the present disclosure.

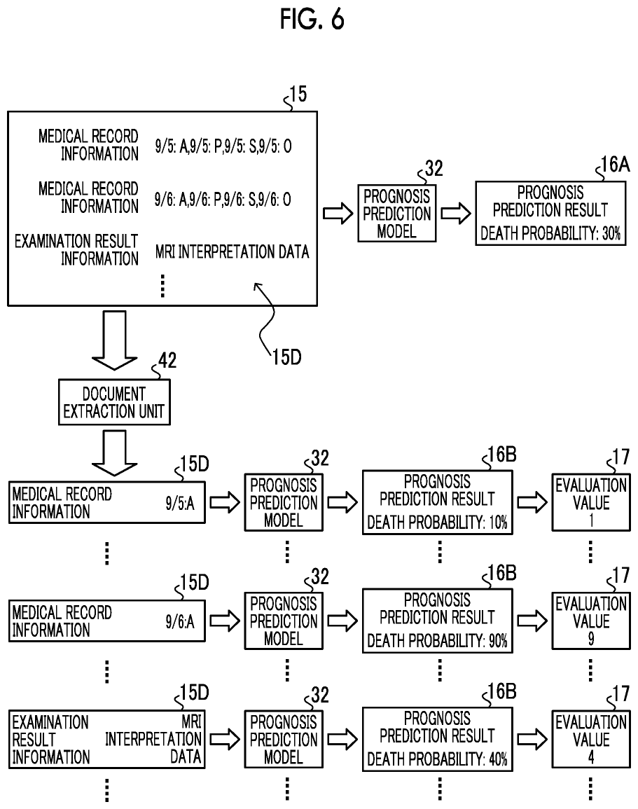

In the prognosis prediction model 32 according to the present embodiment is a model that outputs a probability that the patient is in a death state, specifically, a death probability as a prognosis prediction result 16 in a case in which the patient information 15 is input, as shown in FIG. 2. It should be noted that, in the present embodiment, a prognosis prediction result 16A (see FIG. 6) output in a case in which all the document data 15D included in the patient information 15 are input, a prognosis prediction result 16B (see FIG. 6) output in a case in which each document data 15D is input, and the like are collectively referred to without distinction, the prognosis prediction result output from the prognosis prediction model 32 is simply referred to as the prognosis prediction result 16.

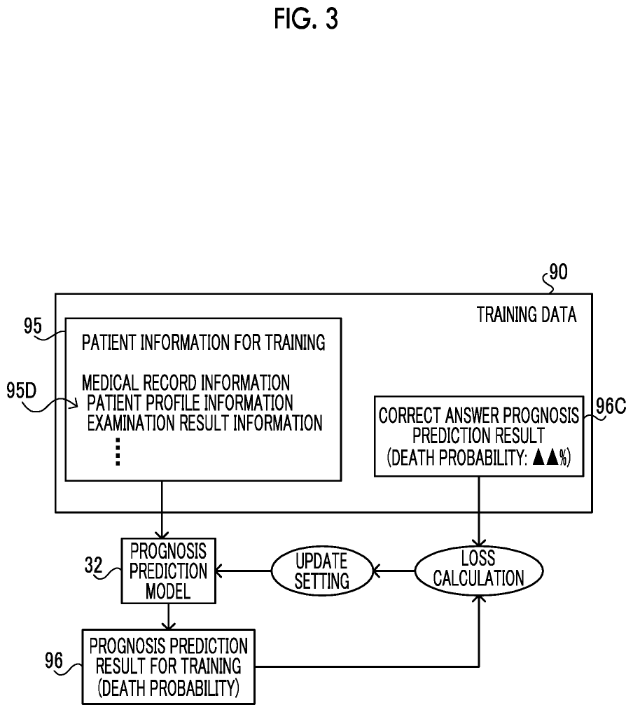

As shown in FIG. 3 as one example, the prognosis prediction model 32 according to the present embodiment is trained by being given with training data 90, which is also called train data or teacher data, in a training phase. The training data 90 is a set of patient information for training 95 and a correct answer prognosis prediction result 96C. The patient information for training 95 includes a plurality of document data for training 95D related to the medical care of a certain patient. The correct answer prognosis prediction result 96C is, for example, the death probability obtained from a result of actually observing the prognosis of the patient. Specifically, it is assumed that “the death probability of the patient who has actually died is 1 (100%)” and “the death probability of a patient who has not died is 0 (0%)”. It should be noted that the death probability is not limited to 100% and 0%, and various adjustments can be made. For example, in a case in which a period until death is long, the death probability may be reduced from 100%. It should be noted that, the present disclosure is not limited to the present embodiment, and as the correct answer prognosis prediction result 96C, for example, the death probability actually given to the patient by a doctor with reference to the document data for training 95D may be used.

In the training phase, the patient information for training 95 is vectorized and input to the prognosis prediction model 32 for each document data for training 95D. The prognosis prediction model 32 outputs a prognosis prediction result for training 96 to the patient information for training 95. A loss calculation of the prognosis prediction model 32 using a loss function is performed based on the prognosis prediction result for training 96 and the correct answer prognosis prediction result 96C. Then, various coefficients of the prognosis prediction model 32 are subjected to update setting according to a result of the loss calculation, and the prognosis prediction model 32 is updated according to the update setting.

In the training phase, the series of pieces of processing of the input of the patient information for training 95 to the prognosis prediction model 32, the output of the prognosis prediction result for training 96 from the prognosis prediction model 32, the loss calculation, the update setting, and the update of the prognosis prediction model 32 are repeatedly performed while exchanging the training data 90. The series of repetitions are terminated in a case in which the prediction accuracy of the prognosis prediction result for training 96 with respect to the correct answer prognosis prediction result 96C reaches a predetermined set level. As described above, the trained prognosis prediction model 32 is generated.

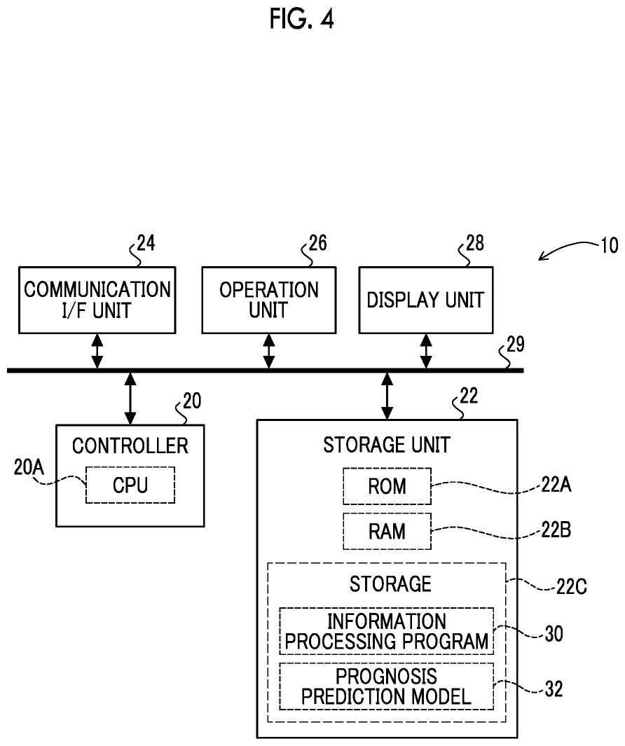

As shown in FIG. 4, the information processing apparatus 10 according to the present embodiment comprises a controller 20, a storage unit 22, a communication interface (I/F) unit 24, an operation unit 26, and a display unit 28. The controller 20, the storage unit 22, the communication OF unit 24, the operation unit 26, and the display unit 28 are connected to each other via a bus 29 such as a system bus or a control bus so that various types of information can be exchanged.

The controller 20 according to the present embodiment controls an overall operation of the information processing apparatus 10. The controller 20 is a processor, and comprises a central processing unit (CPU) 20A. In addition, the controller 20 is connected to the storage unit 22 to be described below. It should be noted that the controller 20 may comprise a graphics processing unit (GPU).

The operation unit 26 is used by the user to input, for example, an instruction or various types of information related to the prognosis prediction of the specific patient. The operation unit 26 is not particularly limited, and examples thereof include various switches, a touch panel, a touch pen, and a mouse. The display unit 28 displays the prognosis prediction result 16, the document data 15D, various types of information, and the like. It should be noted that the operation unit 26 and the display unit 28 may be integrated into a touch panel display.

The communication OF unit 24 performs communication of various types of information with the patient information DB 14 via the network 19 by the wireless communication or the wired communication. The information processing apparatus 10 receives the patient information 15 from the patient information DB 14 via the communication OF unit 24 by the wireless communication or the wired communication.

The storage unit 22 comprises a read only memory (ROM) 22A, a random access memory (RAM) 22B, and a storage 22C. Various programs and the like executed by the CPU 20A are stored in the ROM 22A in advance. Various data are transitorily stored in the RAM 22B. The storage 22C stores an information processing program 30, the prognosis prediction model 32, various types of other information, and the like executed by the CPU 20A. The storage 22C is a non-volatile storage unit, and is, for example, an HDD or an SSD.

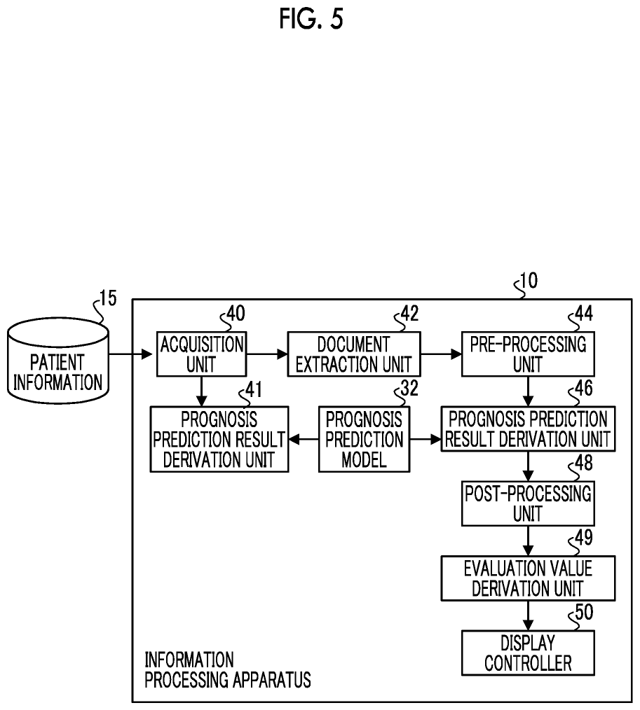

Further, FIG. 5 shows a functional block diagram of one example of the configuration of the information processing apparatus 10 according to the present embodiment. As shown in FIG. 5, the information processing apparatus 10 comprises an acquisition unit 40, a prognosis prediction result derivation unit 41, a document extraction unit 42, a pre-processing unit 44, a prognosis prediction result derivation unit 46, a post-processing unit 48, an evaluation value derivation unit 49, and a display controller 50. As one example, in the information processing apparatus 10 according to the present embodiment, in a case in which the CPU 20A of the controller 20 executes the information processing program 30 stored in the storage 22C, the CPU 20A functions as the acquisition unit 40, the prognosis prediction result derivation unit 41, the document extraction unit 42, the pre-processing unit 44, the prognosis prediction result derivation unit 46, the post-processing unit 48, the evaluation value derivation unit 49, and the display controller 50.

The acquisition unit 40 has a function of acquiring the patient information 15 of the specific patient from the patient information DB 14. As one example, in a case in which the acquisition unit 40 according to the present embodiment receives patient identification information representing the specific patient who is a target of the prognosis prediction, the acquisition unit 40 acquires the patient information 15 corresponding to the received patient identification information from the patient information DB 14 via the network 19. The acquisition unit 40 outputs the acquired patient information 15 to the prognosis prediction result derivation unit 41 and the document extraction unit 42.

The prognosis prediction result derivation unit 41 is used to train the prognosis prediction model 32. As shown in FIG. 6, the prognosis prediction result derivation unit 41 vectorizes all the document data 15D included in the patient information 15, inputs the vectorized document data 15D to the prognosis prediction model 32, and acquires the output prognosis prediction result 16A in a unit of the patient information. In other words, the prognosis prediction result derivation unit 41 derives the prognosis prediction result 16A for each patient information 15 by using the prognosis prediction model 32.

The document extraction unit 42 has a function of extracting the document data 15D from the patient information 15 based on a predetermined reference. As one example, the document extraction unit 42 according to the present embodiment extracts the document data 15D in a unit of a single sentence, by using one single sentence included in the patient information 15 as one document data 15D. It should be noted that the reference for extracting the document data 15D from the patient information 15 is not particularly limited, and for example, the association date may be the same as the reference. In such a case, for example, in the example shown in FIG. 6, as one document data 15D, “9/5: A, 9/5: P, 9/5: S, 9/5: O” is extracted. The document extraction unit 42 outputs the extracted document data 15D to the pre-processing unit 44.

The pre-processing unit 44 has a function of performing pre-processing with respect to the extracted document data 15D before inputting to the prognosis prediction model 32. A length of a text is different between the entire patient information 15 and the extracted document data 15D. Therefore, in the present embodiment, the normalization for adjusting the length of the text of the document data 15D to the connected length of the texts of all the document data 15D included in the patient information 15 is performed as the pre-processing. It should be noted that the normalization method is not particularly limited. For example, a method may be adopted in which a value in a case of vectorizing the document data 15D for inputting to the prognosis prediction model 32 is normalized by the number of the document data 15D included in the patient information 15. Further, for example, a method may be adopted in which the extracted document data 15D are repeatedly connected to obtain the length that can be regarded as equivalent to the connected length of the texts of all the document data 15D included in the patient information 15.

It should be noted that the pre-processing by the pre-processing unit 44 is not always needed. For example, in a case in which a machine learning model which is not affected by the length of the input document (text), such as averaging the values of the input vectors, is adopted as the prognosis prediction model 32, pre-processing does not have to be performed.

The pre-processing unit 44 outputs the document data 15D, which is subjected to the pre-processing, to the prognosis prediction result derivation unit 46. It should be noted that, in a case in which the normalization is performed as described above, in a case of the document data 15D in which the text is short, particularly the document data 15D in which the text is a word sentence including only one word, an evaluation value 17 to be described in detail below tends to be high. Therefore, the pre-processing unit 44 does not have to output the document data 15D in which the length of the sentence (text) is relatively short, for example, the document data 15D in which the total number of included words is equal to or lower than a predetermined number to the prognosis prediction result derivation unit 46.

As shown in FIG. 6, the prognosis prediction result derivation unit 46 has a function of, for each document data 15D, vectorizing the document data 15D, inputs the vectorized document data 15D to the prognosis prediction model 32, and acquiring the output prognosis prediction result 16B in a unit of the document. It should be noted that, in addition to the vectorized document data 15D, the patient profile information and the examination result information used in the training phase of the prognosis prediction model 32 may be used as input information. The prognosis prediction result derivation unit 46 outputs the acquired prognosis prediction result 16B for each patient information 15 to the post-processing unit 48.

The post-processing unit 48 has a function of performing post-processing on the prognosis prediction result 16B with respect to the pre-processing which is performed. As described above, in a case in which the normalization is performed, the evaluation value 17 to be described in detail below tends to be high in the document data in which the sentence (text) is short. Therefore, the post-processing unit 48 performs correction as the post-processing. For example, the post-processing unit 48 may perform the post-processing of performing the normalization by adding a sentence (text) length to the prognosis prediction result 16B. As the post-processing in such a case, for example, the post-processing unit 48 may normalize the prognosis prediction result 16B by the following expression (1).

log(number of words included in document data 15D)×prognosis prediction result 16B (1)

The post-processing unit 48 outputs the prognosis prediction result 16B, which is subjected to the post-processing, to the evaluation value derivation unit 49.

The evaluation value derivation unit 49 derives the evaluation value 17 for each document data 15D according to the prognosis prediction result 16, which is subjected to the post-processing. The evaluation value 17 according to the present embodiment has a correlation with the prognosis prediction result 16B in a unit of the document. As one example, in the present embodiment, since the prognosis prediction model 32 is a model that derives the probability that the patient is in the death state and outputs the death probability as the prognosis prediction result 16B, the value of the evaluation value 17 is higher as the value of the prognosis prediction result 16B in a unit of the document is higher. It should be noted that, in a case in which the prognosis prediction model 32 is a model that outputs a survival probability having a reciprocal relationship with the death probability as the prognosis prediction result 16B as the derivation of the probability that the patient is in the death state, unlike the present embodiment, the value of the evaluation value 17 is higher as the value of the prognosis prediction result 16B in a unit of the document is lower. As described above, in the present embodiment, the value of the evaluation value 17 is higher as it is predicted that the death state is more likely to occur. Stated another way, the value of the evaluation value 17 is higher as the prognosis prediction result 16B shows a more extreme value. It should be noted that, in the present embodiment, the evaluation value 17 is represented as a specific numerical value, but may be represented by, for example, “high”, “medium”, “low”, or the like. The evaluation value derivation unit 49 outputs the evaluation value 17 derived for each document data 15D to the display controller 50.

The display controller 50 specifies the document data 15D, which is a display target, from among all the plurality of document data 15D included in the patient information 15 based on the evaluation value 17 for each document data 15D. For example, the display controller 50 specifies a predetermined number of the document data 15D as the display targets in descending order of the evaluation value 17. In addition, the display controller 50 specifies the document data 15D of which the evaluation value 17 is equal to or higher than a predetermined value as the display target.

Further, in a case of specifying the display target, the document data 15D may be selected one by one by using a method of Beam Search. In such a case, first, the display controller 50 extracts the highest K document data 15D in the ranking of the evaluation value 17 from all the document data 15D included in the patient information 15 as the document data 15D to which a first display priority having the highest display priority is given. Then, other document data 15D included in the remaining document data 15D included in the patient information 15 are added to the extracted document data 15D and ranked based on the evaluation value 17, and a second display priority, which is the next to the first display priority, is given to the highest K document data 15D. This processing is repeated until a predetermined number of the document data 15D are specified or the total length obtained by adding the lengths of all the document data 15D to which the display priority is given reaches a predetermined length.

In addition, the display controller 50 specifies a display order in which the document data 15D is displayed based on the evaluation value 17. For example, the display controller 50 specifies the display order such that the display priority is raised in descending order of the evaluation value 17. It should be noted that the display controller 50 may adopt, as the display order, a time-series order based on the date and time associated with the document data 15D. In a case in which the display order is the time-series order, the display priority is higher as the date and time are newer. In addition, the display order in which the order according to the evaluation value 17 and the time-series order are combined may be adopted. It should be noted that, in such a case, the burden on the user who reads the document data 15D is larger as the document data 15D is longer, and thus the length of the document data 15D may be added as a penalty. Specifically, the penalty that is larger as the length of the document data 15D is longer may be added.

It should be noted that, in a case in which at least one of the display target or the display order is determined in advance, the display controller 50 need only specify which of the display target and the display order is not determined in advance, and may omit the specification of the display target and the specification of the display order in a case in which both the display target and the display order are determined in advance. For example, in a case in which it is determined in advance that all the document data 15D are used as the display targets, the display controller 50 need only specify the display order.

In addition, the display controller 50 performs control of displaying the document data 15D specified as the display target on the display unit 28 in the specified display order. It should be noted that the display controller 50 may also control of displaying the prognosis prediction result 16A derived by the prognosis prediction result derivation unit 41 on the display unit 28.

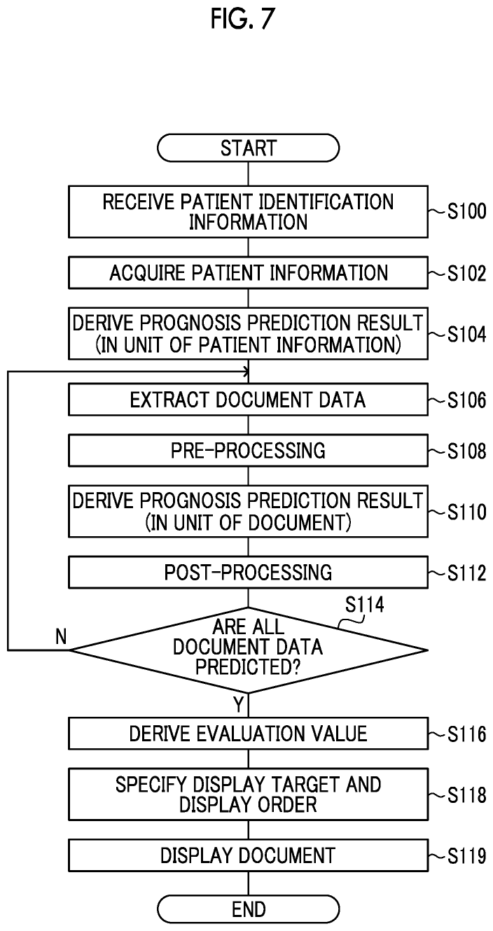

Hereinafter, an action of the information processing apparatus 10 according to the present embodiment will be described with reference to the drawings. FIG. 7 shows a flowchart showing one example of a flow of information processing executed by the information processing apparatus 10 according to the present embodiment. The information processing apparatus 10 according to the present embodiment executes the information processing shown in FIG. 7 in a case in which the CPU 20A of the controller 20 executes the information processing program 30 stored in the storage 22C based on a start instruction or the like of the user performed by the operation unit 26, as one example.

In step S100 of FIG. 7, as described above, the acquisition unit 40 receives the patient identification information designated by the user using the operation unit 26. In next step S102, as described above, the acquisition unit 40 acquires the patient information 15 associated with the patient identification information from the patient information DB 14 via the network 19.

In next step S104, as described above, the prognosis prediction result derivation unit 41 derives the prognosis prediction result 16A in a unit of the patient information by using all the document data 15D included in the patient information 15 as input of the prognosis prediction model 32. In next step S106, as described above, the document extraction unit 42 extracts one document data 15D from the patient information 15. In next step S108, as described above, the pre-processing unit 44 performs the pre-processing on the document data 15D and normalizes the length of the document data 15D.

In next step S110, as described above, the prognosis prediction result derivation unit 46 derives the prognosis prediction result 16B in a unit of the document by using the document data 15D extracted in step S106 as input of the prognosis prediction model 32. In next step S112, as described above, the post-processing unit 48 performs the post-processing on the prognosis prediction result derivation unit 46B in a unit of the document, and performs the normalization.

In next step S114, the document extraction unit 42 determines whether or not the prognosis prediction result 16B is derived for all the document data 15D included in the patient information 15. In a case in which the prognosis prediction result 16B is not yet derived for all the document data 15D, a negative determination is made in the determination of step S114, the processing returns to step S106, and the pieces of processing of steps S106 to S112 are repeated. On the other hand, in a case in which the prognosis prediction result 16B is derived for all the document data 15D, a positive determination is made in the processing of step S114, and the processing proceeds to step S116.

In step S116, as described above, the evaluation value derivation unit 49 derives the evaluation value 17 having the correlation with the prognosis prediction result 16B in a unit of the document for each document data 15D. In next step S118, as described above, the display controller 50 specifies the display target from among all the document data 15D included in the patient information 15, and also specifies the display order of the document data 15D, which is the display target.

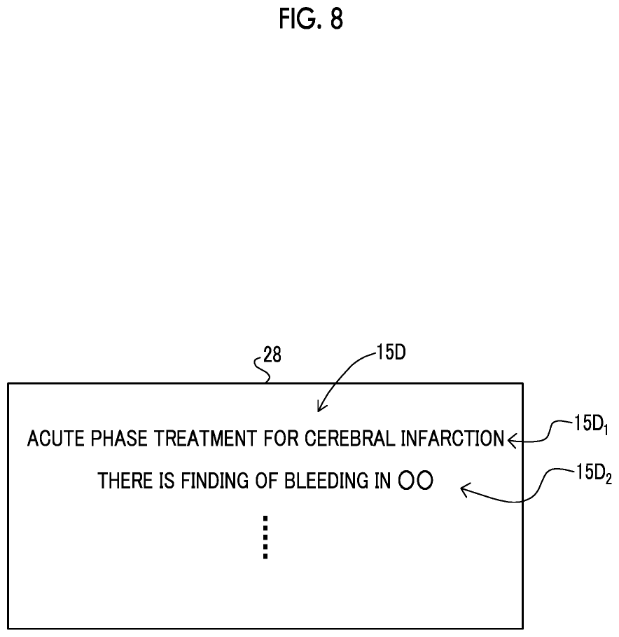

In next step S119, as described above, the display controller 50 displays the document corresponding to the document data 15D, which is the display target, on the display unit 28 in the specified display order. FIG. 8 is a diagram showing one example of a state in which the document data 15D, which is the display target, is displayed on the display unit 28 in the specified display order. In the example shown in FIG. 8, the first display priority is given to document data 15D₁, and the second display priority is given to document data 15D₂. In this way, by displaying the document data 15D which is the display target specified in step S118 on the display unit 28 in the specified display order, useful information for the specific patient for which the prognosis prediction is performed by the prognosis prediction model 32 is displayed in descending order of a degree of importance. In a case in which the processing of step S119 is terminated, the information processing shown in FIG. 7 is terminated.

It should be noted that, in the present embodiment, the embodiment is described in which the evaluation value 17 is derived based on the prognosis prediction result 16B in a unit of the document output from the prognosis prediction model 32, but the present disclosure is not limited to the present embodiment. For example, information processing according to a modification example 1 may be applied.

### Modification Example 1

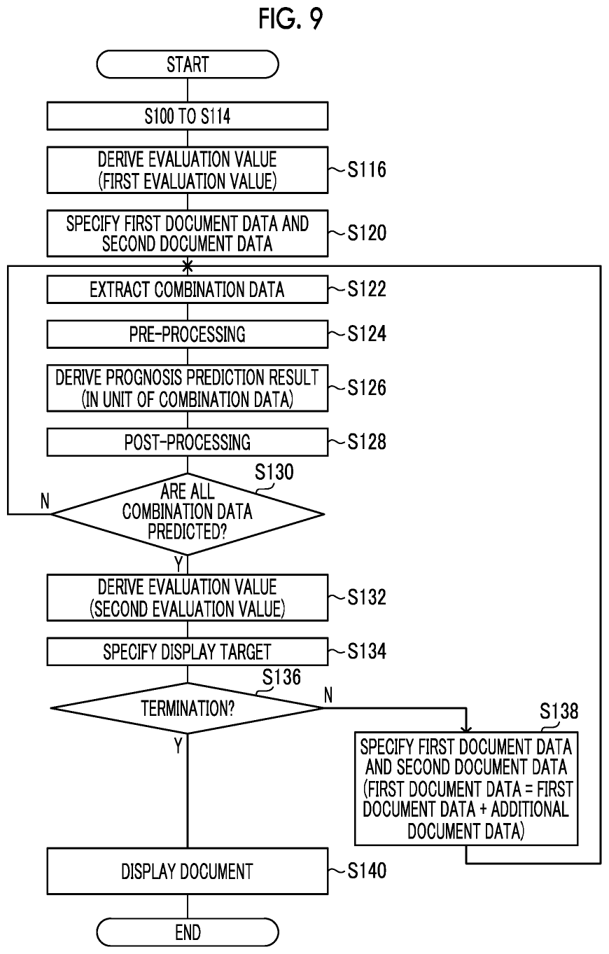

FIG. 9 shows a flowchart showing one example of a flow of information processing executed by the information processing apparatus 10 according to the present modification example. The pieces of processing of steps S100 to S114 are the same as the pieces of processing of steps S100 to S114 of the information processing described above with reference to FIG. 7, and thus the description thereof will be omitted.

In next step S116, the evaluation value derivation unit 49 derives the evaluation value 17 having the correlation with the prognosis prediction result 16B in a unit of the document for each document data 15D, in the same manner as in step S116 of the information processing shown in FIG. 9. It should be noted that the evaluation value given by this processing is used as a first evaluation value.

In next step S120, the document extraction unit 42 specifies first document data and second document data from among the document data 15D included in the patient information 15 based on the first evaluation value. As one example, the document extraction unit 42 according to the present embodiment specifies the document data 15D having the highest first evaluation value as the first document data, and specifies the document data 15D other than the first document data included in the patient information 15 as the second document data.

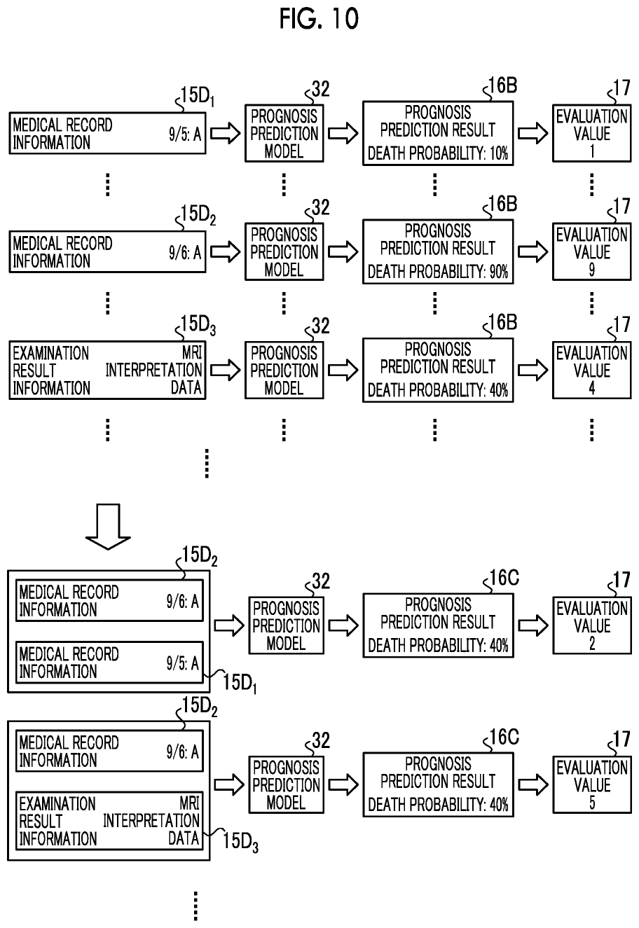

In the example shown in FIG. 10, the document extraction unit 42 specifies, from among the document data 15D₁ to 15D₃, the document data 15D₂ as the first document data and specifies the document data 15D₁ and 15D₃ as the second document data, based on the evaluation value 17.

In next step S122, the document extraction unit 42 extracts combination data in which one of a plurality of second document data is combined with the first document data specified in step S120. In the example shown in FIG. 10, the combination data in which the document data 15D₂, which is the first document data, and the document data 15D₁, which is the second document data, are combined, and the combination data in which the document data 15D₂, which is the first document data, and the document data 15D₃, which is the second document data, are combined are shown.

In next step S124, as described above, the pre-processing unit 44 performs the pre-processing on the combination data extracted in step S122, and normalizes the length of the combination data.

In next step S126, as shown in FIG. 10, the prognosis prediction result derivation unit 46 derives a prognosis prediction result 16C in a unit of the combination data as input of the prognosis prediction model 32 by using the combination data extracted in step S122. In next step S128, as described above, the post-processing unit 48 performs the post-processing on the prognosis prediction result 16C in a unit of the combination data, and performs the normalization.

In next step S130, the document extraction unit 42 determines whether or not the prognosis prediction result 16C is derived for all the combination data. In a case in which the prognosis prediction result 16C is not yet derived for all the combination data, a negative determination is made in the determination of step S130, the processing returns to step S122, and the pieces of processing of steps S122 to S128 are repeated. In other words, the processing of deriving the prognosis prediction result 16C in a unit of the combination data is sequentially repeated by varying the second document data to be combined with the first document data. On the other hand, in a case in which the prognosis prediction result 16C is derived for all the combination data, a positive determination is made in the processing of step S130, and the processing proceeds to step S132.

In step S132, as described above, the evaluation value derivation unit 49 derives the evaluation value 17 having the correlation with the prognosis prediction result 16C in a unit of the combination data for each combination data. The evaluation value 17 derived here is used as a second evaluation value.

In next step S134, the display controller 50 specifies the display target. Here, the first document data is specified as the display target. In addition, the document data 15D, which is the display target, is specified from among the plurality of document data 15D as the second document data based on the second evaluation value. For example, the display controller 50 specifies the document data 15D having the highest second evaluation value as the display target. It should be noted that, from the meaning that the document data 15D specified as the display target from among the document data 15D used as the second document data is added to the first document data and used as the display target, the term “additional document data” is used.

In next step S136, the document extraction unit 42 determines whether or not to terminate the addition of the document data 15D, which is the display target. As one example, the document extraction unit 42 according to the present embodiment terminates the addition of the document data 15D in a case in which a predetermined termination condition is satisfied. Examples of the predetermined termination condition include a case in which the number of the document data 15D, which is the display target, reaches a predetermined number, and a case in which the total length of the lengths of the texts of the plurality of document data 15D, which are the display targets, is equal to or longer than a predetermined length. In a case in which the predetermined termination condition is not satisfied, a negative determination is made in the determination in step S136, and the processing proceeds to step S138. In step S138, the document extraction unit 42 specifies the first document data and the second document data again. Here, the document data in which the document data 15D, which is the additional document data, is added to the document data 15D previously used as the first document data is specified as new first document data. In addition, the document data 15D other than the new first document data included in the patient information 15 is specified as the second document data.

On the other hand, in step S136, in a case in which the termination condition is satisfied, a negative determination is made in the determination, and the processing proceeds to step S140. In step S140, the display controller 50 displays the document corresponding to the document data 15D, which is the display target, on the display unit 28, in the same manner as in step S119 of the information processing shown in FIG. 7. In a case in which the processing of step S119 is terminated, the information processing shown in FIG. 9 is terminated.

### Second Embodiment

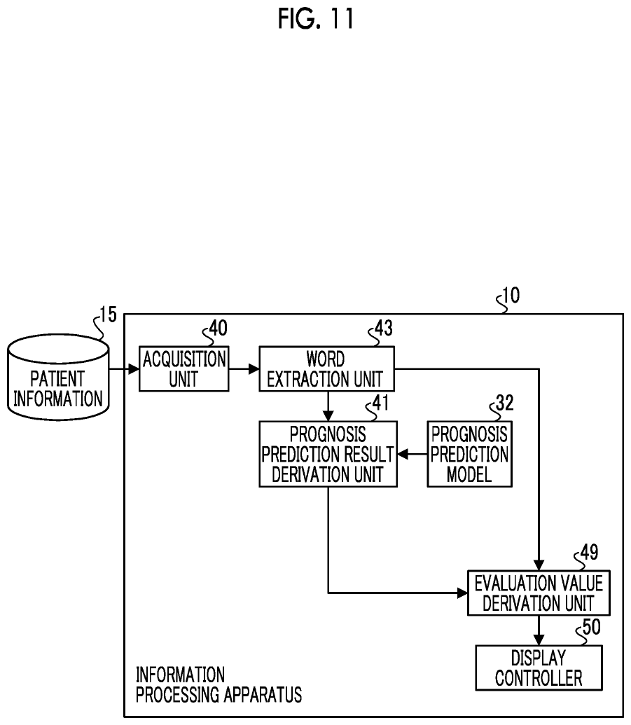

In the present embodiment, an embodiment will be described in which the evaluation value 17 is derived based on the prognosis prediction result 16B in a unit of the word output from the prognosis prediction model 32. FIG. 11 shows a functional block diagram of one example of the configuration of the information processing apparatus 10 according to the present embodiment. The information processing apparatus 10 according to the present embodiment is different from the information processing apparatus 10 (see FIG. 5) according to the first embodiment in that the pre-processing unit 44, the prognosis prediction result derivation unit 46, and the post-processing unit 48 are not provided, and a word extraction unit 43 is further provided.

The word extraction unit 43 has a function of extracting word data 15W from all the document data 15D included in the patient information 15 acquired by the acquisition unit 40. It should be noted that the method by which the word extraction unit 43 extracts the word data 15W from the document data 15D is not particularly limited. For example, the word extraction unit 43 may extract the morphological elements obtained by performing the morphological element analysis with a known morphological element analyzer, such as JUMAN, as the word data 15W. The word extraction unit 43 outputs all the extracted word data 15W to the prognosis prediction result derivation unit 41 and the prognosis prediction result derivation unit 46.

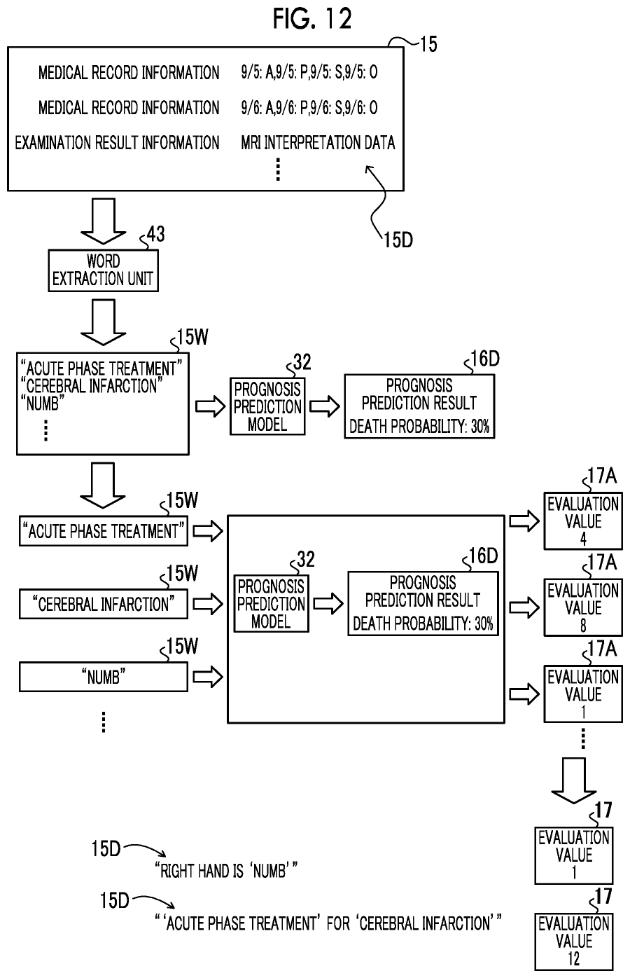

As shown in FIG. 12, the prognosis prediction result derivation unit 41 according to the present embodiment vectorizes all the word data 15W, inputs the vectorized word data 15W to the prognosis prediction model 32, and acquires the output prognosis prediction result 16D in a unit of the patient information. In other words, the prognosis prediction result derivation unit 41 derives the prognosis prediction result 16D for each patient information 15 by using the prognosis prediction model 32. It should be noted that, in a case in which the word data 15W is vectorized, a known term frequency-inverse document frequency (TF-IDF) or bag of words (BoW) may be applied to perform the vectorization.

On the other hand, the evaluation value derivation unit 49 according to the present embodiment derives an evaluation value 17A for each word data 15W according to the prognosis prediction result 16D. As the evaluation value used here, a so-called “degree of contribution” to the machine learning model obtained by a method, such as the LIME, a so-called “contribution feature amount” to the machine learning model obtained by a gradient boosting decision tree (GBDT), and the like can be applied. In addition, the evaluation value derivation unit 49 derives the evaluation value 17 (evaluation value 17 in a unit of the document) for each document data 15D based on the evaluation value 17A in a unit of the word. As one example, as shown in FIG. 12, the evaluation value derivation unit 49 according to the present embodiment derives an addition value (total value) obtained by adding the evaluation value 17A of the word data 15W included in the document data 15D as the evaluation value 17 of the document data 15D. In the example shown in FIG. 12, for the document data 15D that “right hand is numb”, the word data 15W of “numb” is included, and thus an evaluation value 1 of the word data 15W of “numb” is used as a value of the evaluation value 17 of the document data 15D. In addition, for the document data 15D of “acute phase treatment for cerebral infarction”, two word data 15W of “cerebral infarction” and “acute phase treatment” are included, and thus a value (8+4=12) obtained by adding an evaluation value 8 of the word data 15W of “cerebral infarction” and an evaluation value 4 of the word data 15W of “acute phase treatment” is used as a value of the evaluation value 17 of the document data 15D. It should be noted that, in a case in which the document data 15D includes a plurality of the same word data 15W, for the same word data 15W, the evaluation value 17A may be lowered and added, or the evaluation value 17A does not have to be added. It should be noted that the total value of the evaluation values 17A according to the present embodiment is one example of a statistical value according to the present disclosure.

As described above, in the present embodiment, the total value of the evaluation values 17A of the word data 15W included in the document data 15D is used as the evaluation value 17 in a unit of the document, but a value other than the total value may be used, and the statistical value obtained from the evaluation value 17 in a unit of the document need only be used. For example, an average value obtained by dividing the total value by the number of added word data 15W or the number of nouns may be used as the evaluation value 17 of the document data 15D.

The evaluation value derivation unit 49 outputs the derived evaluation value 17 in a unit of the document to the display controller 50.

Similar to the display controller 50 according to the first embodiment, the display controller 50 according to the present embodiment specifies the document data 15D, which is the display target, and specifies the display order based on the evaluation value 17 in a unit of the document.

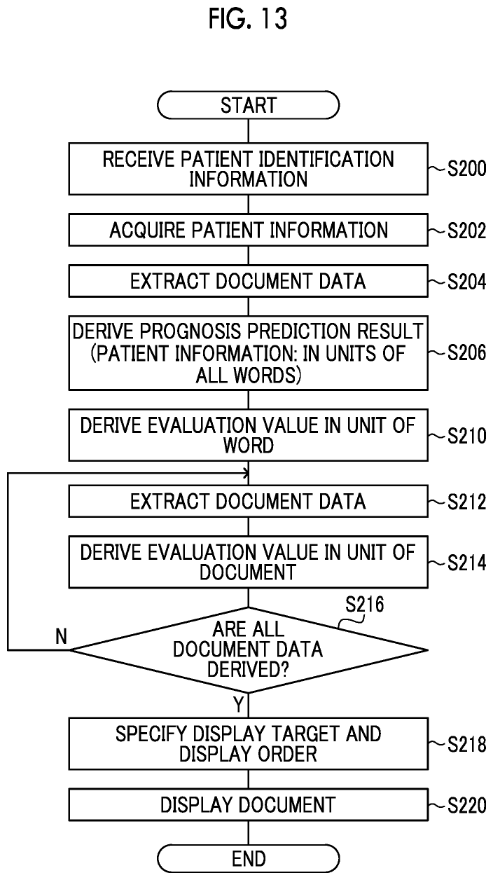

Hereinafter, an action of the information processing apparatus 10 according to the present embodiment will be described with reference to the drawings. FIG. 13 shows a flowchart showing one example of a flow of information processing executed by the information processing apparatus 10 according to the present embodiment.

In step S200 of FIG. 13, the acquisition unit 40 receives the patient identification information in the same manner as in step S100 of the information processing (see FIG. 7) according to the first embodiment. In next step S202, the acquisition unit 40 acquires the patient information 15 associated with the patient identification information from the patient information DB 14 via the network 19 in the same manner as in step S102 of the information processing (see FIG. 7) according to the first embodiment.

In next step S204, as described above, the word extraction unit 43 extracts all the word data 15W from all the document data 15D included in the patient information 15 acquired in step S202 by the morphological element analysis or the like.

In next step S206, as described above, the prognosis prediction result derivation unit 41 derives the prognosis prediction result 16D in a unit of the patient information (in a unit of all the words) by using all the word data 15W included in the patient information 15 as input of the prognosis prediction model 32.

In next step S210, as described above, the evaluation value derivation unit 49 derives the evaluation value 17A in a unit of the word, which is the degree of contribution or the like.

In next step S212, the evaluation value derivation unit 49 extracts one document data 15D from the patient information 15. Next step S214, the evaluation value derivation unit 49 derives the evaluation value 17 (evaluation value 17 in a unit of the document) of the document data 15D extracted in step S212 based on the evaluation value 17A in a unit of the word.

In next step S216, the evaluation value derivation unit 49 determines whether or not the evaluation value 17 in a unit of the document is derived for all the document data 15D included in the patient information 15. In a case in which the evaluation value 17 in a unit of the document is not yet derived for all the document data 15D, a negative determination is made in the determination in step S216, the processing returns to step S212, and the pieces of processing of steps S212 and S214 are repeated. On the other hand, in a case in which the evaluation value 17 in a unit of the document is derived for all the document data 15D, a positive determination is made in the determination in step S216, and the processing proceeds to step S218.

In step S218, the display controller 50 specifies the display target and the display order from among all the document data 15D included in the patient information 15 based on the evaluation value 17 in a unit of the document, as described above. In next step S220, in the same manner as in step S119 of the information processing (see FIG. 7) according to the first embodiment, the display controller 50 displays the document corresponding to the document data 15D, which is the display target, on the display unit 28. In a case in which the processing of step S220 is terminated, the information processing shown in FIG. 13 is terminated.

It should be noted that the display controller 50 may display at least one of the evaluation value 17 of the document data 15D or the word data 15W having a high the evaluation value 17A included in the document data 15D in association with each document data 15D. For example, the display controller 50 may display the word data 15W of which the evaluation value 17A is higher than a certain threshold value, or the word data 15W whose number is equal to or larger than a predetermined threshold value (for example, 3) in descending order of the evaluation value 17A among the word data 15W included in the document data 15D. Further, in the above, a case in which the display controller 50 specifies the display target and the display order, have been described. However, the present disclosure is not limited thereto. For example, a display form may be changed based on the evaluation value 17, instead of the display target and the display order. Here, the display form may include, for example, color of cell, term, or sentence of the document data 15D. Further, changing the display form may include, for example, changing the color of the document data that has respectively high evaluation value to a color that a user can easily pay attention to, compared to the document data that has respectively low evaluation value.

It should be noted that, in the present embodiment as well, the pre-processing, the post-processing, or the like performed in the information processing of the first embodiment may be performed.

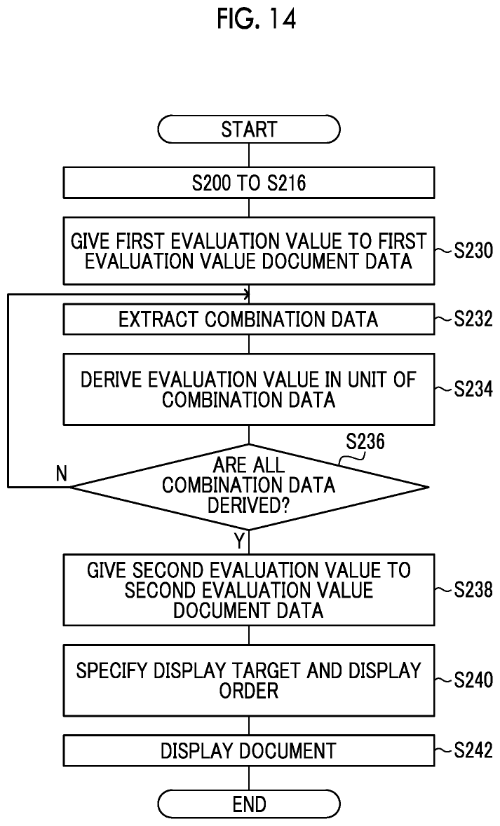

It should be noted that, in the present embodiment, the embodiment of the modification example 1 of the first embodiment may be combined. FIG. 14 shows a flowchart showing one example of a flow of information processing executed by the information processing apparatus 10 in such a case.

In such a case, the word extraction unit 43 extracts a plurality of word data 15W from each document data 15D included in the patient information 15, as described above. In addition, the evaluation value derivation unit 49 derives the evaluation value 17A in a unit of the word for each word data 15W, as described above. In addition, the evaluation value derivation unit 49 derives the evaluation value 17 for each document based on the evaluation value 17A of the word data 15W included in the document data 15D for each document data 15D, and gives the first evaluation value to the document data 15D having the greatest evaluation value 17 for each document as first evaluation value document data in step S230 of FIG. 14. The evaluation value 17 for each document in such a case is one example of a first statistical value according to the present disclosure. It should be noted that the first evaluation value need only be any value having a correlation with the evaluation value 17, and specific numerical values and the like are not particularly limited.

In next step S232, the evaluation value derivation unit 49 extracts a plurality of combination data in which the first evaluation value document data and each of the plurality of document data 15D other than the first evaluation value document data included in the patient information 15 are combined. In next step S234, the evaluation value derivation unit 49 derives the evaluation value 17 for each combination data based on the evaluation value 17A of the word data 15W included in the combination data for each combination data. It should be noted that, among the word data 15W included in the document data 15D to be combined with the first evaluation value document data, the evaluation value 17A in a unit of the word of the word data 15W included in the first evaluation value document data is made to be relatively lower than the evaluation value 17A in a unit of the word of the word data 15W which is not included in the first evaluation value document data. It should be noted that, as a result of setting the evaluation value 17A to be relatively low, the evaluation value 17A may be made to “0”. In other words, an embodiment may be adopted in which the evaluation value 17A is counted only once for each word data 15W.

In next step S236, the evaluation value derivation unit 49 determines whether or not all the combination data are extracted. In a case in which all the combination data are not yet extracted, a negative determination is made in the determination in step S236, the processing returns to step S232, and the pieces of processing of steps S232 and S234 are repeated. On the other hand, in a case in which all the combination data are extracted, a positive determination is made in the determination in step S236, and the processing proceeds to step S238.

In step S238, the evaluation value derivation unit 49 gives the second evaluation value lower than the first evaluation value to the combination data having the greatest evaluation value 17 derived in step S234 as the second evaluation value document data. The evaluation value 17 for each combination data in such a case is one example of a second statistical value according to the present disclosure.

In next step S240, the display controller 50 specifies the document data 15D, which is the display target, from among all the document data 15D included in the patient information 15, and specifies the display order of the document data 15D, which is the display target, based on the first evaluation value and the second evaluation value.

In next step S242, as described above, the display controller 50 displays the document corresponding to the document data 15D, which is the display target, on the display unit 28 in the specified display order. In a case in which the processing of step S242 is terminated, the information processing shown in FIG. 14 is terminated.

As described above, for the prognosis prediction model 32 that uses the patient information 15 including the plurality of document data 15D as input and outputs the output data, the CPU 20A of the information processing apparatus 10 according to each embodiment described above derives the evaluation value 17 in the prognosis prediction model 32 for each document data 15D included in the patient information 15.

As described above, with the information processing apparatus 10 of each embodiment described above, the evaluation value 17 in the prognosis prediction model 32 that uses the patient information 15 including the plurality of document data 15D as input can be obtained for each document data. As a result, since at least one of the specification of the document data 15D to be provided to the user or the specification of the order of the provision can be performed based on the evaluation value 17, it is possible to provide the user with useful information for the specific patient in descending order of the degree of importance.

### Third Embodiment

In the present embodiment, a learning method of the machine learning model used in each embodiment described above will be described.

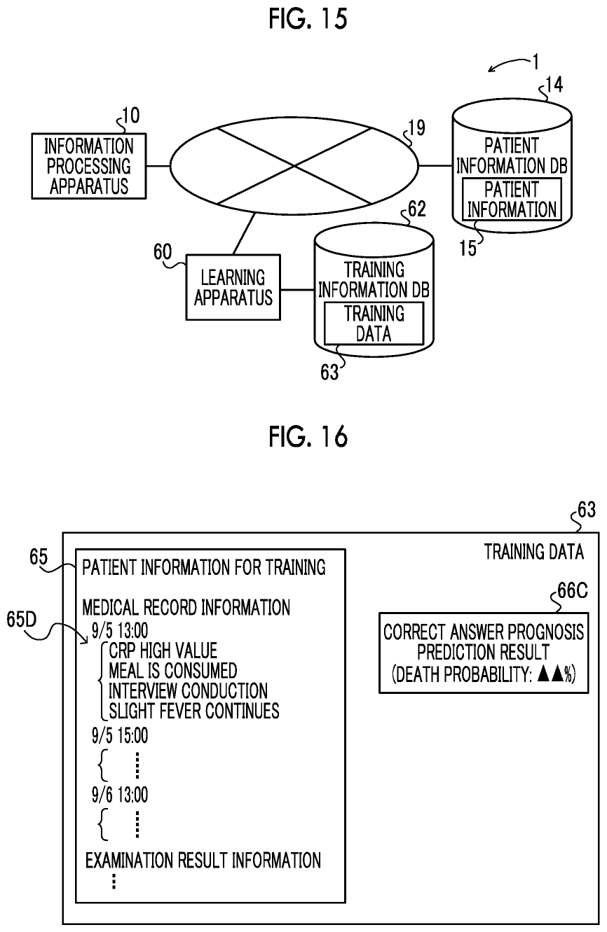

FIG. 15 shows a configuration diagram showing one example of the overall configuration of the information processing system 1 according to the present embodiment. As shown in FIG. 15, the information processing system 1 according to the present embodiment is different from the information processing system 1 (see FIG. 1) according to the embodiment described above in that a learning apparatus 60 and a training information DB 62 are further provided. The learning apparatus 60 is connected to the information processing apparatus 10 by the wired communication or the wireless communication via the network 19, and is also connected to the training information DB 62 by the wired communication or the wireless communication.

Training data 63 used to train the machine learning model is stored in the training information DB 62. The training information DB 62 is realized by a storage medium, such as an HDD, an SSD, and a flash memory, provided in a server apparatus in which a software program for providing functions of a database management system to a general-purpose computer is installed.

As one example, as shown in FIG. 16, the training data 63 according to the present embodiment is a set of patient information for training 65 and a correct answer prognosis prediction result 66C. The patient information for training 65 includes a plurality of document data for training 65D related to the medical care of a certain patient. The document data for training 65D is, for example, data for each document included in each of the medical record information, the patient profile information, the examination result information, and the like. For example, in FIG. 16, each of “CRP high value”, “meal is consumed”, “interview conduction”, and “slight fever continues” corresponding to “9/5 13:00” in “medical record information” is the document data for training 65D. It should be noted that the document data for training 65D may be in a unit of one sentence, or may be in a unit of a plurality of sentences that satisfy a predetermined reference. Examples of the predetermined reference include a reference for each category, such as “S”, “O”, “A”, and “P”, and a reference for each medical record. On the other hand, similar to the correct answer prognosis prediction result 96C (see FIG. 3) according to the embodiment described above, the correct answer prognosis prediction result 66C is, for example, the death probability obtained from the result of actually observing the prognosis of the patient. The patient information for training 65 according to the present embodiment is one example of a document data group for training according to the present disclosure, and the document data for training 65D according to the present embodiment is one example of document data for training according to the present disclosure. In addition, the correct answer prognosis prediction result 66C according to the present embodiment is one example of correct answer data (also called as “gold data” or “target document”) according to the present disclosure.

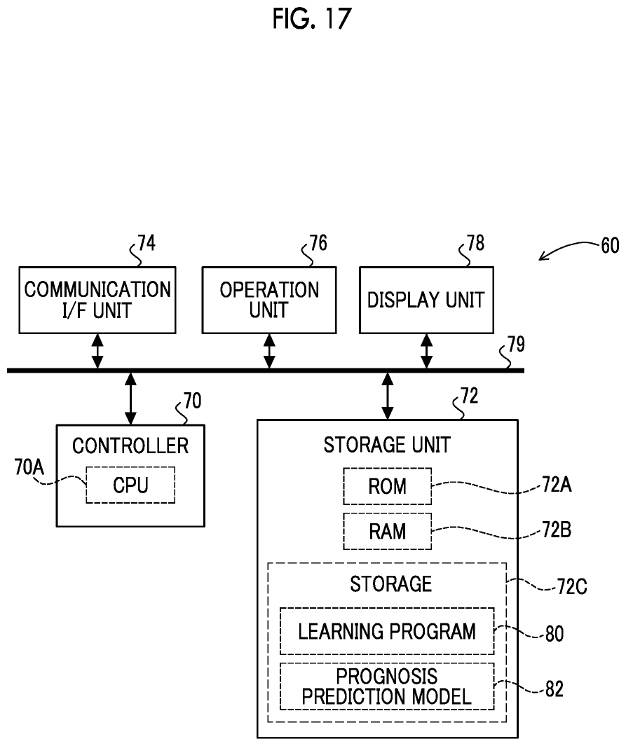

As shown in FIG. 17, the learning apparatus 60 according to the present embodiment comprises a controller 70, a storage unit 72, a communication I/F unit 74, an operation unit 76, and a display unit 78. The controller 70, the storage unit 72, the communication I/F unit 74, the operation unit 76, and the display unit 78 are connected to each other via a bus 79 such as a system bus or a control bus so that various types of information can be exchanged.

The controller 70 according to the present embodiment controls an overall operation of the learning apparatus 60. The controller 70 is a processor, and comprises a CPU 70A. It should be noted that the controller 70 may comprise a GPU.

The operation unit 76 is used for the user to input an instruction, information, and the like related to training of the prognosis prediction model 82. The operation unit 76 is not particularly limited, and is, for example, various switches, a touch panel, a touch pen, a mouse, a microphone for voice input, and a camera for gesture input. The display unit 78 displays information related to training of the prognosis prediction model 82 and the like. It should be noted that the operation unit 76 and the display unit 68 may be integrated into a touch panel display.

The communication I/F unit 64 performs communication of various types of information with the information processing apparatus 10 via the network 19 by the wireless communication or the wired communication. In addition, the learning apparatus 60 receives the training data 63 from the training information DB 62 via the communication I/F unit 74 by the wireless communication or the wired communication.

The storage unit 72 comprises a ROM 72A, a RAM 72B, and a storage 72C. Various programs and the like executed by the CPU 70A are stored in the ROM 72A in advance. Various data are transitorily stored in the RAM 72B. The storage 72C stores a learning program 80 executed by the CPU 70A, a trained prognosis prediction model 82, various types of other information, and the like. The storage 72C is a non-volatile storage unit, and is, for example, an HDD or an SSD.

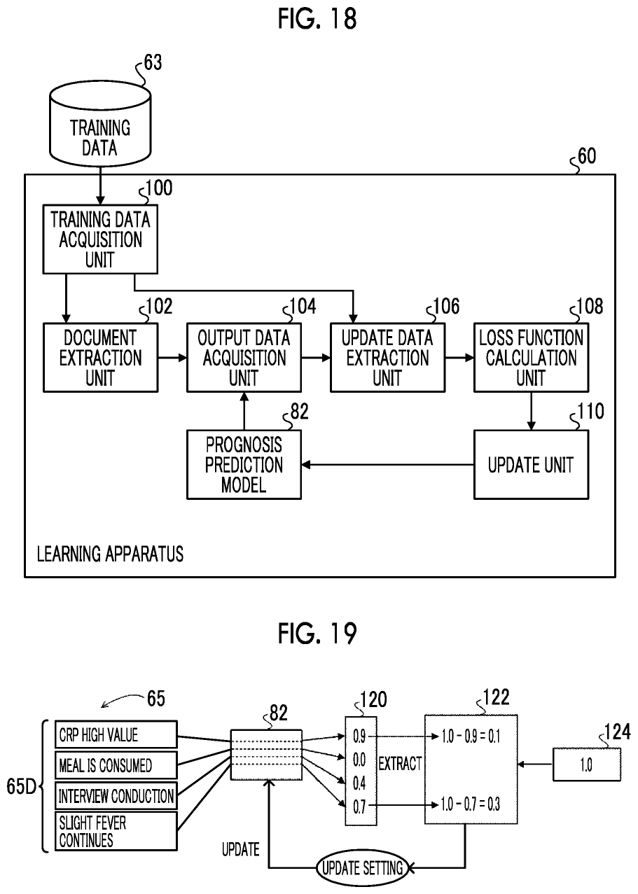

Further, FIG. 18 shows a functional block diagram of one example of the configuration of the learning apparatus 60 according to the present embodiment. As shown in FIG. 18, the learning apparatus 60 comprises a training data acquisition unit 100, a document extraction unit 102, an output data acquisition unit 104, an update data extraction unit 106, a loss function calculation unit 108, and an update unit 110. As one example, in the learning apparatus 60 according to the present embodiment, in a case in which the CPU 70A of the controller 70 executes the learning program 80 stored in the storage 72C, the CPU 70A functions as the training data acquisition unit 100, the document extraction unit 102, the output data acquisition unit 104, the update data extraction unit 106, the loss function calculation unit 108, and the update unit 110.

The training data acquisition unit 100 has a function of acquiring the training data 63 from the training information DB 62. The training data acquisition unit 100 outputs the patient information for training 65 among the acquired training data 63 to the document extraction unit 102, and outputs the correct answer prognosis prediction result 66C to the update data extraction unit 106.

The document extraction unit 102 has a function of extracting the document data for training 65D from the patient information for training 65 based on a predetermined reference. The document extraction unit 102 outputs the extracted document data for training 65D to the output data acquisition unit 104.

The output data acquisition unit 104 has a function of acquiring the output data which is output from the prognosis prediction model 82 as a result of inputting the document data for training 65D to the prognosis prediction model 82. As one example, as shown in FIG. 19, the output data acquisition unit 104 according to the present embodiment inputs the patient information for training 65D extracted by the document extraction unit 102 one by one to the prognosis prediction model 82. Specifically, the output data acquisition unit 104 vectorizes the document data for training 65D and inputs vectorized document data for training 65D to the prognosis prediction model 82. Then, the output data acquisition unit 104 has a function of acquiring each output data 120 output from the prognosis prediction model 82. The output data acquisition unit 104 outputs a plurality of acquired output data 120 to the update data extraction unit 106. It should be noted that, in the present embodiment, as the output data 120, a value obtained by converting the death probability expressed by a percentage to a small number is used. For example, “0.9” for the output data 120 in FIG. 19 means that the death probability is 90%. It should be noted that, similar to the output data 120, as correct answer data 124 corresponding to the correct answer prognosis prediction result 66C, a value obtained by correcting the death probability of the correct answer expressed by a percentage to a small number is used. For example, “1.0” for the correct answer data 124 in FIG. 19 means that the death probability is 100%.

The update data extraction unit 106 has a function of extracting a part of the document data for training 65D, as update data for updating the prognosis prediction model 82, from the plurality of document data for training 65D based on the output data 120 and the correct answer prognosis prediction result 66C. As one example, the update data extraction unit 106 according to the present embodiment extracts a part of the document data for training 65D, as the update data, from the plurality of document data for training 65D based on a degree of similarity between the output data 120 and the correct answer data 124.

It can be regarded that the degree of similarity between the output data 120 and the correct answer data 124 is higher as the output data 120 has a smaller difference between the correct answer data 124 and the output data 120. Therefore, the update data extraction unit 106 according to the present embodiment extracts, as the update data, the document data for training 65D in a case in which the output data 120 of the highest X % (X is a predetermined threshold value) in descending order of the degree of similarity is output among the plurality of output data 120. It should be noted that, unlike the present embodiment, an embodiment may be adopted in which the update data extraction unit 106 extracts, as the update data, the document data for training 65D in a case of outputting the output data 120 in which the difference between the output data 120 and the correct answer data 124 is equal to or higher than the threshold value. The update data extraction unit 106 outputs the document data for training 65D extracted as the update data to the loss function calculation unit 108.

For the document data for training 65D extracted as the update data by the update data extraction unit 106, the loss function calculation unit 108 calculates a loss function 122 representing a degree of difference between the correct answer data 124 and the output data 120 for each document data for training 65D. Specifically, a loss function 122 according to the present embodiment is an absolute value of the difference between the correct answer data 124 and the output data 120. The loss function calculation unit 108 outputs the loss function 122, which is a calculation result, to the update unit 110.

It should be noted that, in the present embodiment, the embodiment is described in which the update data extraction unit 106 extracts the document data for training 65D as the update data, and then the loss function calculation unit 108 calculates the loss function for the extracted document data for training 65D, but an embodiment may be adopted in which, unlike the present embodiment, the update data extraction unit 106 extracts the update data simultaneously with the calculation of the loss function by the loss function calculation unit 108. Specifically, the following expressions (2) and (3) may be used in a form of a calculation expression. It should be noted that, in Expressions (2) and (3), Lᵢ represents a loss for i-th training data, T represents a sentence set of the medical record for a certain hospitalization, yt represents a correct answer label of t-th sentence, y\hat{ }t represents an output value of the prognosis prediction model 82 for the t-th sentence, r represents an output order of the sentence in the hospitalization, and l_{T} represents a document of the medical record for the hospitalization. α and γ are hyper parameters for determining a degree to which only a part of sentences are considered for each hospitalization.

$${L}_{i} = {\sum }_{t ∈ T} {w ( yt - \hat{y} t )}^{2} \qquad ( 2 )$$

$$w = \{ \begin{matrix}{( r / {l}_{T} )}^{α} & r \geq γ \cdot {l}_{T} \\ ϵ & r < γ \cdot {l}_{T}\end{matrix} \qquad ( 3 )$$

The update unit 110 has a function of updating the prognosis prediction model 82 based on the loss function 122.

By repeating each processing of the output data acquisition unit 104, the update data extraction unit 106, the loss function calculation unit 108, and the update unit 110, the accuracy of the prognosis prediction model 82 is improved, and the trained prognosis prediction model 82 is generated.

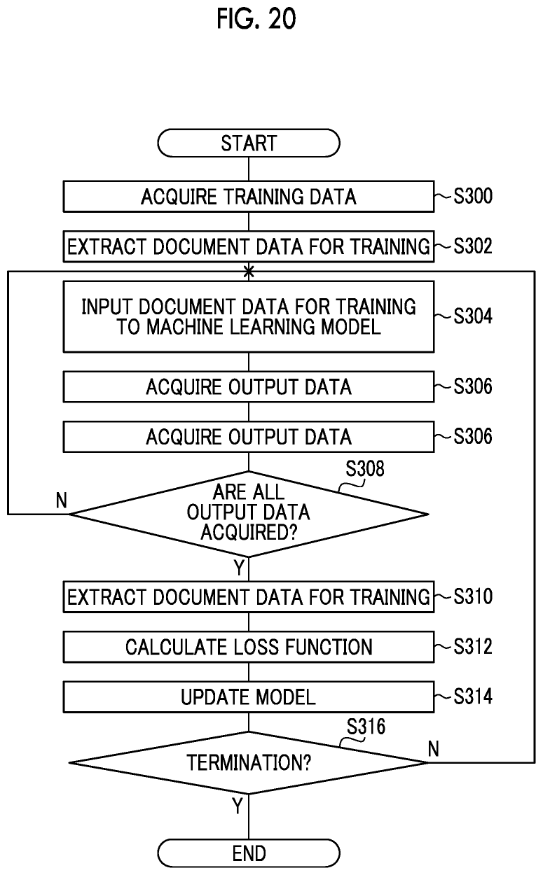

Hereinafter, an action of the learning apparatus 60 according to the present embodiment will be described with reference to the drawings. FIG. 20 shows a flowchart showing one example of a flow of learning processing executed by the information processing apparatus 10 according to the present embodiment. The learning apparatus 60 according to the present embodiment executes the learning processing shown in FIG. 20 in a case in which the CPU 70A of the controller 70 executes the learning program 80 stored in the storage 72C based on a start instruction or the like of the user performed by the operation unit 76, as one example.

In step S300 of FIG. 20, as described above, the training data acquisition unit 100 acquires the training data 63 from the training information DB 62.

In next step S302, the document extraction unit 102 extracts the plurality of document data for training 65D from the patient information for training 65 of the training data 63, as described above.

In next step S304, the output data acquisition unit 104 inputs one of the plurality of document data for training 65D extracted in step S302 to the prognosis prediction model 82. In next step S306, the output data acquisition unit 104 acquires the output data 120 output from the prognosis prediction model 82 as a result of the processing of step S304.

In next step S308, the output data acquisition unit 104 determines whether or not the output data 120 is acquired for all the document data for training 65D extracted in step S302. Until the output data 120 is acquired for all the document data for training 65D, a negative determination is made in the determination in step S308, the processing returns to step S304, and the pieces of processing of steps S304 and 306 are repeated. On the other hand, in a case in which the output data 120 is acquired for all the document data for training 65D, a positive determination is made in the determination in step S308, and the processing proceeds to step S310.

In step S310, as described above, the update data extraction unit 106 extracts the document data for training 65D based on the degree of similarity between the output data 120 and the correct answer data 124.

In next step S312, as described above, the loss function calculation unit 108 calculates the loss function 122 for the document data for training 65D extracted in step S310.

In next step S314, the update unit 110 updates the prognosis prediction model 82 based on the loss function 122 calculated in step S312, as described above.

In next step S316, the update unit 110 determines whether or not to terminate the learning processing shown in FIG. 20. As one example, the update unit 110 according to the present embodiment terminates the learning processing shown in FIG. 20 in a case in which the prediction accuracy of the prognosis prediction model 82 with respect to the correct answer data 124 reaches the predetermined set level. In the update unit 110, in a case in which the prediction accuracy of the prognosis prediction model 82 with respect to the correct answer data 124 does not reach the predetermined set level, a negative determination is made in the determination of step S316, the processing returns to step S304, and the pieces of processing of steps S304 to S314 are repeated. On the other hand, in a case in which the prediction accuracy of the prognosis prediction model 82 with respect to the correct answer data 124 reaches the predetermined set level, a positive determination is made in the determination in step S316, and the learning processing shown in FIG. 19 is terminated.

It should be noted that a condition for terminating the learning processing is not limited to the condition described above. For example, a condition may be used in which the value of the loss function described above is not updated as compared with the previous step, or a condition may be used in which an index for measuring the performance of the document extraction is prepared and the value is not updated. It should be noted that, as the index for measuring the performance of the document extraction, a rate of match or the degree of similarity in a case of comparison between a document list extracted as the document having the degree of contribution to the prognosis prediction by using the prognosis prediction model 82 and a document list determined to be important academically or by the user can be considered.

### Modification Example

The learning apparatus 60 according to the present embodiment is not limited to the embodiment described above, and various modification examples can be made.

For example, in the embodiment described above, the document data for training 65D having a low relevance to the prediction result is not used to update the prognosis prediction model 82, but an embodiment may be adopted in which the document data for training 65D is also used to update the prognosis prediction model 82. For example, an embodiment may be adopted in which, for the document data for training 65D having a low relevance to the prediction result, the loss function calculation unit 108 calculates the loss function 122 with lower weighting than the document data for training 65D having a high relevance to the prediction result, and the update unit 110 updates the prognosis prediction model 82 by using the loss function as well.

In addition, for the document data for training 65D having a high relevance to the prediction result, the loss function calculation unit 108 may calculate the loss function 122 by performing weighting based on the output data 120 and the loss function 122. For example, the loss function calculation unit 108 may calculate the loss function 122 by performing weighting that is larger as the degree of similarity is higher according to the degree of similarity. As a specific example, a value obtained by the following expression (1) in which G is a reverse order of the descending order of the degree of similarity, that is, an order of arrangement in the order of a low degree of similarity, and the weighting is performed by using a preset λ may be used as a weight.

G^{λ}/total number of document data for training 65D that has a high relevance to prediction result (1)

In addition, instead of the expression (1) described above, a weighting value set according to the value of the output data 120 may be used.

In addition, in a case in which the number of updates satisfies a specific condition in a case in which the update of the prognosis prediction model 82 is repeated, the learning apparatus 60 may maintain or increase the number of the document data for training 65D extracted in the processing of step S310. For example, an embodiment may be adopted in which, in every ten updates, all the document data for training 65D may be extracted one time, and the document data for training 65D of the highest X % having a high degree of similarity may be extracted one time.

In addition, different labels may be given to the document data for training 65D based on the correct answer prognosis prediction result 66C. For example, in a case in which the correct answer prognosis prediction result 66C of the prognosis prediction model 82 indicates the probability that the correct answer prognosis prediction result 66C is that immediately before discharge from the hospital, the document data for training 65D is separated into the document data immediately before discharge from the hospital and the other document data, and labels corresponding to the document data immediately before discharge from the hospital and the other document data, respectively, are given. The loss function may be calculated for each of the document data groups to which the respective labels are given, and the prognosis prediction model 82 may be updated by using a plurality of calculated loss functions. By doing so, it is possible to generate the prognosis prediction model 82 suitable for extracting the document data indicating that the state is good, focusing on the fact that the state of the patient is good immediately before discharge from the hospital.

The learning apparatus 60 trained as described above trains the prognosis prediction model 82 by updating the prognosis prediction model 82 by preferentially using a part of the document data for training 65D in which the output data 120 is similar to the correct answer data 124 among the plurality of document data for training 65D. Since the prognosis prediction model 82 is updated without using the document data for training 65D having a low relevance to the prediction result, which is included in the plurality of document data for training 65D, or by using the document data for training 65D having a low relevance to the prediction result while decreasing the importance, the prognosis prediction model 82 with higher accuracy can be generated.

In addition, the prognosis prediction model 82 trained by the learning apparatus 60 according to the present embodiment is a high-performance machine learning model that receives the document data as input. Therefore, instead of inputting each document data group to the prognosis prediction model 82, each document data can be input to the prognosis prediction model 82 and used to obtain the prediction result.

It should be noted that, in each embodiment described above, as one example of the machine learning model according to the present disclosure, the prognosis prediction model 32 is described, which outputs, as the output data, the probability that a certain patient is in the death state, which is one example of a state according to a predetermined task, but the machine learning model is not limited to the prognosis prediction model 32. For example, the present disclosure can also be applied to the prediction model that uses, as the input data, a document data group including a plurality of company reports including words related to personnel change information, product information, and the like as the document data 15D, and outputs, as the output data, a prediction result for company trends, such as a probability that a business status of the company is deteriorated.

Further, in the embodiment described above, for example, as the hardware structure of the processing unit that executes various processing, such as the acquisition unit 40, the prognosis prediction result derivation unit 41, the document extraction unit 42, the word extraction unit 43, the pre-processing unit 44, the prognosis prediction result derivation unit 46, the post-processing unit 48, the evaluation value derivation unit 49, and the display controller 50, the following various processors can be used. As described above, in addition to the CPU that is a general-purpose processor that executes software (program) to function as various processing units, the various processors include a programmable logic device (PLD) that is a processor of which a circuit configuration can be changed after manufacture, such as a field programmable gate array (FPGA), and a dedicated electric circuit that is a processor having a circuit configuration that is designed for exclusive use in order to execute specific processing, such as an application specific integrated circuit (ASIC).

One processing unit may be configured by using one of the various processors or may be configured by using a combination of two or more processors of the same type or different types (for example, a combination of a plurality of FPGAs or a combination of a CPU and an FPGA). In addition, a plurality of the processing units may be configured by using one processor.

A first example of the configuration in which the plurality of processing units are configured by using one processor is an embodiment in which one processor is configured by using a combination of one or more CPUs and the software and this processor functions as the plurality of processing units, as represented by computers, such as a client and a server. A second example thereof is an embodiment of using a processor that realizes the function of the entire system including the plurality of processing units by one integrated circuit (IC) chip, as represented by a system on chip (SoC) or the like. In this way, as the hardware structure, the various processing units are configured by using one or more of the various processors described above.

Further, more specifically, as the hardware structure of the various processors, an electric circuit (circuitry) in which circuit elements, such as semiconductor elements, are combined can be used.

In addition, in each embodiment described above, an aspect is described in which the information processing program 30 is stored (installed) in the storage unit 22 in advance, but the present disclosure is not limited to this. The information processing program 30 may be provided in a form of being recorded in a recording medium, such as a compact disc read only memory (CD-ROM), a digital versatile disc read only memory (DVD-ROM), and a universal serial bus (USB) memory. Moreover, each information processing program 30 may be provided in a form of being downloaded from an external device via a network. That is, an embodiment may be adopted in which the program described in the present embodiment (program product) is distributed from an external computer, in addition to the provision by the recording medium.

In regard to the embodiments described above, the following appendixes will be further disclosed.

Appendix 1

An information processing apparatus comprising: at least one processor, in which the processor is configured to: for a machine learning model that uses a document data group including a plurality of document data as input and outputs output data, derive an evaluation value in the machine learning model for each document data included in the document data group.

Appendix 2

The information processing apparatus according to appendix 1, in which the processor is configured to: perform at least one of specification of the document data, which is a display target, from the document data group or specification of a display order of a document according to the document data based on the derived evaluation value.

Appendix 3

The information processing apparatus according to appendix 1 or 2, in which the processor is configured to: use each document data as input of the machine learning model to acquire document unit output data which is output for each document data; and derive the evaluation value for each document data based on the document unit output data.

Appendix 4

The information processing apparatus according to appendix 3, in which the evaluation value has a correlation with the document unit output data.

Appendix 5

The information processing apparatus according to any one of appendixes 1 to 4, in which the processor is configured to: normalize each document data included in the document data group; and derive the evaluation value for each normalized document data.

Appendix 6

The information processing apparatus according to appendix 1 or 2, in which the processor is configured to: extract a plurality of word data from each document data included in the document data group; derive the evaluation value in the machine learning model as a word unit evaluation value for each word data; and derive the evaluation value according to a statistical value of the word unit evaluation value of the word data included in the document data for each document data.

Appendix 7

The information processing apparatus according to appendix 1 or 2, in which the document data having a greatest first evaluation value, which is derived for each document data, is used as first document data, and each of the plurality of document data other than the first document data included in the document data group is used as second document data, and the processor is configured to: use each combination data in which the first document data and the second document data are combined as input of the machine learning model to derive a second evaluation value from output data which is output for each combination data.

Appendix 8

The information processing apparatus according to appendix 7, in which the processor is configured to: give a first display priority to the first document data; and give a second display priority, which is lower than the first display priority, to the second document data based on the second evaluation value.

Appendix 9

The information processing apparatus according to appendix 1 or 2, in which the processor is configured to: extract a plurality of word data from each document data included in the document data group; derive the evaluation value in the machine learning model as a word unit evaluation value for each word data; derive a first statistical value of the word unit evaluation value of the word data included in the document data for each document data to give a first evaluation value to first evaluation value document data which is the document data having a greatest first statistical value; derive, for a plurality of combination data in which the first evaluation value document data, and each of the plurality of document data other than the first evaluation value document data included in the document data group are combined, a second statistical value of the word unit evaluation value of the word data included in the combination data for each combination data to give a second evaluation value, which is lower than the first evaluation value, to second evaluation value document data which is the document data having a greatest second statistical value; and set, in derivation of the second statistical value, the word unit evaluation value of the word data included in the first evaluation value document data among the word data included in the document data combined with the first evaluation value document data to be relatively lower than the word unit evaluation value of the word data which is not included in the first evaluation value document data.

Appendix 10

The information processing apparatus according to any one of appendixes 1 to 9, in which the machine learning model is a model that is used to carry out a predetermined task and outputs a probability of a state according to the task as the output data.

Appendix 11

The information processing apparatus according to any one of appendixes 1 to 10, in which the plurality of document data included in the document data group is document data representing a document related to a medical care of a specific patient, and the machine learning model is a model that predicts a state of the specific patient.

Appendix 12

An information processing method executed by a processor of an information processing apparatus including at least one processor, the information processing method comprising: for a machine learning model that uses a document data group including a plurality of document data as input and outputs output data, deriving an evaluation value in the machine learning model for each document data included in the document data group.

Appendix 13

An information processing program causing a processor of an information processing apparatus including at least one processor, to execute a process comprising: for a machine learning model that uses a document data group including a plurality of document data as input and outputs output data, deriving an evaluation value in the machine learning model for each document data included in the document data group.

Appendix 14

A learning apparatus of a machine learning model that uses a plurality of document data as input and outputs output data, the learning apparatus comprising: at least one processor, in which the processor is configured to: use, for a plurality of document data for training, each document data for training as input of the machine learning model to acquire output data which is output for each document data for training; calculate, for a part of the document data for training from the plurality of document data for training, a loss function representing a degree of difference between correct answer data and the output data for each document data for training based on the output data obtained for each document data for training and the correct answer data; and update the machine learning model based on the loss function.

Appendix 15

The learning apparatus according to appendix 14, in which the processor is configured to: extract the part of document data for training based on a degree of similarity between the output data and the correct answer data.

Appendix 16

The learning apparatus according to appendix 14 or 15, in which the processor is configured to: calculate, also for another document data for training other than the part of document data for training, the loss function with a weight smaller than a weight of the part of document data for training for each data for training; and update the machine learning model based also on the loss function of the other document data for training.

Appendix 17

The learning apparatus according to any one of appendixes 14 to 16, in which the processor is configured to: calculate, for the part of document data for training, the loss function by performing weighting based on the output data obtained for each document data for training and the correct answer data.

Appendix 18

The learning apparatus according to appendix 17, in which the processor is configured to: set weighting to be larger as a degree of similarity between the output data and the correct answer data is higher.

Appendix 19

The learning apparatus according to any one of appendixes 14 to 18, in which the processor is configured to: repeatedly update the machine learning model based on the loss function obtained from the part of document data for training; and change the number of the part of document data for training to be extracted, according to the number of updates of the machine learning model.

Appendix 20

The learning apparatus according to any one of appendixes 14 to 19, in which each document data for training is given with a label representing a type of an associated prediction result of the machine learning model, and the processor is configured to: extract the document data for training for each type of the label.

Appendix 21

An information processing apparatus comprising: at least one processor, in which the processor is configured to: for a machine learning model that uses a document data group including a plurality of document data as input and outputs output data, derive an evaluation value in the machine learning model for each document data included in the document data group, and the machine learning model is a machine learning model trained by a learning apparatus of the machine learning model that uses the document data group including the plurality of document data as input and outputs the output data, the learning apparatus including: at least one processor for training, in which the processor for training is configured to: use each document data for training included in a document data group for training as input of the machine learning model to acquire output data which is output for each document data for training; calculate, for a part of the document data for training from the document data group for training, a loss function representing a degree of difference between correct answer data and the output data for each document data for training based on the output data obtained for each document data for training and the correct answer data; and update the machine learning model based on the loss function.

Appendix 22

An information processing system comprising: the information processing apparatus according to any one of appendixes 1 to 11; and the learning apparatus according to any one of appendixes 14 to 20.

Appendix 23

A learning method comprising: via a processor, using, for a plurality of document data for training, each document data for training as input of a machine learning model to acquire output data which is output for each document data for training; calculating, for a part of the document data for training from the plurality of document data for training, a loss function representing a degree of difference between correct answer data and the output data for each document data for training based on the output data obtained for each document data for training and the correct answer data; and updating the machine learning model based on the loss function.

Appendix 24

A learning program causing a processor to execute a process comprising: using, for a plurality of document data for training, each document data for training as input of a machine learning model to acquire output data which is output for each document data for training; calculating, for a part of the document data for training from the plurality of document data for training, a loss function representing a degree of difference between correct answer data and the output data for each document data for training based on the output data obtained for each document data for training and the correct answer data; and updating the machine learning model based on the loss function.

What is claimed is:

1. An information processing apparatus comprising:
at least one processor, wherein the processor is configured to:
for a machine learning model that uses a document data group including a plurality of document data as input and outputs output data, derive an evaluation value in the machine learning model for each document data included in the document data group.

2. The information processing apparatus according to claim 1, wherein the processor is configured to perform at least one of specification of the document data, which is a display target, from the document data group or specification of a display order of a document according to the document data based on the derived evaluation value.

3. The information processing apparatus according to claim 1, wherein the processor is configured to:
use each document data as input of the machine learning model to acquire document unit output data which is output for each document data; and
derive the evaluation value for each document data based on the document unit output data.

4. The information processing apparatus according to claim 3, wherein the evaluation value has a correlation with the document unit output data.

5. The information processing apparatus according to claim 1, wherein the processor is configured to:
normalize each document data included in the document data group; and
derive the evaluation value for each normalized document data.

6. The information processing apparatus according to claim 1, wherein the processor is configured to:
extract a plurality of word data from each document data included in the document data group;
derive the evaluation value in the machine learning model as a word unit evaluation value for each word data; and
derive the evaluation value according to a statistical value of the word unit evaluation value of the word data included in the document data for each document data.

7. The information processing apparatus according to claim 1, wherein:
the document data having a greatest first evaluation value, which is derived for each document data, is used as first document data, and each of the plurality of document data other than the first document data included in the document data group is used as second document data, and
the processor is configured to use each combination data in which the first document data and the second document data are combined as input of the machine learning model to derive a second evaluation value from output data which is output for each combination data.

8. The information processing apparatus according to claim 7, wherein the processor is configured to:
give a first display priority to the first document data; and
give a second display priority, which is lower than the first display priority, to the second document data based on the second evaluation value.

9. The information processing apparatus according to claim 1, wherein the processor is configured to:
extract a plurality of word data from each document data included in the document data group;
derive the evaluation value in the machine learning model as a word unit evaluation value for each word data;
derive a first statistical value of the word unit evaluation value of the word data included in the document data for each document data to give a first evaluation value to first evaluation value document data which is the document data having a greatest first statistical value;
derive, for a plurality of combination data in which the first evaluation value document data, and each of the plurality of document data other than the first evaluation value document data included in the document data group are combined, a second statistical value of the word unit evaluation value of the word data included in the combination data for each combination data to give a second evaluation value, which is lower than the first evaluation value, to second evaluation value document data which is the document data having a greatest second statistical value; and
set, in derivation of the second statistical value, the word unit evaluation value of the word data included in the first evaluation value document data among the word data included in the document data combined with the first evaluation value document data to be relatively lower than the word unit evaluation value of the word data which is not included in the first evaluation value document data.

10. A learning apparatus of a machine learning model that uses a plurality of document data as input and outputs output data, the learning apparatus comprising:
at least one processor, wherein the processor is configured to:
use, for a plurality of document data for training, each document data for training as input of the machine learning model to acquire output data which is output for each document data for training;
calculate, for a part of the document data for training from the plurality of document data for training, a loss function representing a degree of difference between correct answer data and the output data for each document data for training based on the output data obtained for each document data for training and the correct answer data; and
update the machine learning model based on the loss function.

11. The learning apparatus according to claim 10, wherein the processor is configured to extract the part of document data for training based on a degree of similarity between the output data and the correct answer data.

12. The learning apparatus according to claim 10, wherein the processor is configured to:
calculate, also for another document data for training other than the part of document data for training, the loss function with a weight smaller than a weight of the part of document data for training for each data for training; and
update the machine learning model based also on the loss function of the other document data for training.

13. The learning apparatus according to claim 10, wherein the processor is configured to calculate, for the part of document data for training, the loss function by performing weighting based on the output data obtained for each document data for training and the correct answer data.

14. The learning apparatus according to claim 13, wherein the processor is configured to set weighting to be larger as a degree of similarity between the output data and the correct answer data is higher.

15. The learning apparatus according to claim 10, wherein the processor is configured to:
repeatedly update the machine learning model based on the loss function obtained from the part of document data for training; and
change the number of the part of document data for training to be extracted, according to the number of updates of the machine learning model.

16. The learning apparatus according to claim 10, wherein:
each document data for training is given with a label representing a type of an associated prediction result of the machine learning model, and
the processor is configured to extract the document data for training for each type of the label.

17. An information processing apparatus comprising:
at least one processor, wherein the processor is configured to:
for a machine learning model that uses a document data group including a plurality of document data as input and outputs output data, derive an evaluation value in the machine learning model for each document data included in the document data group,
wherein the machine learning model is a machine learning model trained by a learning apparatus of the machine learning model that uses the document data group including the plurality of document data as input and outputs the output data, the learning apparatus including:
at least one processor for training, wherein the processor for training is configured to:
use each document data for training included in a document data group for training as input of the machine learning model to acquire output data which is output for each document data for training;
calculate, for a part of the document data for training from the document data group for training, a loss function representing a degree of difference between correct answer data and the output data for each document data for training based on the output data obtained for each document data for training and the correct answer data; and
update the machine learning model based on the loss function.

18. An information processing method executed by a processor of an information processing apparatus including at least one processor, the information processing method comprising:
for a machine learning model that uses a document data group including a plurality of document data as input and outputs output data,
deriving an evaluation value in the machine learning model for each document data included in the document data group.

19. A non-transitory computer-readable medium storing an information processing program that is executable by the processor included in the information processing device to perform the information processing method according to claim 18.

20. A learning method comprising:
via a processor,
using, for a plurality of document data for training, each document data for training as input of a machine learning model to acquire output data which is output for each document data for training;
calculating, for a part of the document data for training from the plurality of document data for training, a loss function representing a degree of difference between correct answer data and the output data for each document data for training based on the output data obtained for each document data for training and the correct answer data; and
updating the machine learning model based on the loss function.

21. A non-transitory computer-readable medium storing a learning program that is executable by the processor included in an information processing device to perform the learning method according to claim 20.
